(19) United States
(12) Patent Application Publication
(10) Pub. No.: US 2025/0089965 A1
(43) Pub. Date: Mar. 20, 2025

(54) AUTOMATIC CLEANING DEVICE AND SYSTEM

(71) Applicant: Beijing Roborock Technology Co., Ltd., Changping District, Beijing (CN)

(72) Inventors: Haibin LI, Changping District, Beijing (CN); Yanhui LIU, Changping District, Beijing (CN); Zhibin ZHANG, Changping District, Beijing (CN)

(73) Assignee: Beijing Roborock Technology Co., Ltd., Changping District, Beijing (CN)

(21) Appl. No.: 18/728,056

(22) PCT Filed: May 18, 2022
(86) PCT No.: PCT/CN2022/093608

§ 371 Date: Jul. 10, 2024

(30) Foreign Application Priority Data
Jan. 11, 2022 (CN) 202220066057.1

(51) Int. Cl. A47L 11/40; A47L 9/28

(52) U.S. Cl. CPC A47L 11/4008; A47L 9/2857; A47L 2201/00

(57) ABSTRACT

The present disclosure provides an automatic cleaning device, including: a moving platform, configured to automatically move on an operation surface and comprising a cover plate.

### CROSS-REFERENCE TO RELATED APPLICATION

The present application is a U. S. national stage of the International Patent Application No. PCT/CN2022/093608, which is based on and claims priority to Chinese Patent Application No. 202220066057.1, filed on Jan. 11, 2022, both of which are incorporated herein by reference in its entirety.

### TECHNICAL FIELD

The present application relates to the field of cleaning robot technologies, and in particular to an automatic cleaning device and an automatic cleaning system.

### BACKGROUND ART

Cleaning robots become more and more popular in modern life, and bring convenience to family lives. Cleaning robots include sweeping robots, mopping robots, sweeping and mopping integrated robots, or the like. With the popularity of the cleaning robots, the functions and structures of the cleaning robots become more and more complex, and accordingly, their production cost is getting higher and higher.

In the related art, some cleaning robots are additionally provided with structures or functions such as automatic charging, automatic dust removal, lifting and vibration. In this way, although the cleaning robots are more intelligent, the complexity of various parts of the cleaning robots is increased, causing a lot of inconvenience to subsequent maintenance.

### SUMMARY OF THE INVENTION

According to specific embodiments of the present application, the present application provides an automatic cleaning device, including:
a moving platform, configured to automatically move on an operation surface and including a cover plate, where the cover plate constitutes at least a part of a top surface of the moving platform; and
a button assembly, assembled on the cover plate, where the button assembly includes a button cap and a bracket, the button cap is assembled on the bracket, and the bracket includes a step structure extending in a circumferential direction.

In some embodiments, in an assembled state, the step structure is a step continuously ascending from outside to inside.

In some embodiments, the bracket includes at least one side wall, and an assembly portion is formed on an inner side of the at least one side wall.

In some embodiments, the bracket includes a first side wall extending circumferentially and continuously along an outer edge of the bracket and a second side wall extending circumferentially and continuously along an interior of the bracket, where a first assembly portion is formed between the first side wall and the second side wall, and a second assembly portion is formed inside the second side wall.

In some embodiments, at least a part of the step structure is located on the first assembly portion, and another part of the step structure is located on the second assembly portion.

In some embodiments, each of two ends of the bracket includes a positioning hole, a lower surface of the cover plate is provided with a positioning column corresponding to the positioning hole, and the positioning column passes through the positioning hole to realize fixation of the bracket.

In some embodiments, the bracket further includes a button plate connected by at least one elastic arm, the button plate is configured to move downwards under an external force to implement a pressing function, and the elastic arm is configured to restore the button plate.

In some embodiments, the button cap includes a pressing body portion and at least one protruding portion extending downwards around the pressing body portion; when the button cap is assembled on the bracket, the at least one protruding portion is adapted to the assembly portion formed on the inner side of the at least one side wall.

In some embodiments, the button cap includes a first protruding portion and a second protruding portion extending downwards around the pressing body portion; when the button cap is assembled on the bracket, the first protruding portion and the second protruding portion are adapted to the first assembly portion and the second assembly portion, respectively.

In some embodiments, the button cap includes a third protruding portion connecting the first protruding portion to the second protruding portion, and the third protruding portion extends upwards around the pressing body portion.

In some embodiments, the button cap further includes a first groove and a second groove extending along two sides of the third protruding portion in a surrounding manner, where a depth of the first groove is greater than a depth of the second groove.

In some embodiments, the cover plate includes a button mounting hole, and the pressing body portion is assembled in the button mounting hole, so that a top surface of the pressing body portion is approximately flush with or slightly lower than a top surface of the cover plate.

In some embodiments, the cover plate further includes at least one waterproof rib extending downwards around the button mounting hole, and the at least one waterproof rib is assembled in the first groove and/or the second groove.

In some embodiments, a side wall of the at least one waterproof rib includes a protrusion, and the at least one waterproof rib is assembled in the first groove and/or the second groove in an interference fit manner through the protrusion.

In some embodiments, the cover plate includes a first waterproof rib and a second waterproof rib extending downwards around the button mounting hole, the first waterproof rib is assembled in the first groove in an interference fit manner, and the second waterproof rib is assembled in the second groove.

In some embodiments, the second protruding portion includes two recesses provided at intervals, and in the assembled state, the recesses are configured to accommodate the button plate.

In some embodiments, a shading arm extending downwards is provided between the two recesses provided at intervals.

Compared with the related art, the embodiments of the present application have the following technical effects.

The present application provides an automatic cleaning device, in which the button assembly is assembled on the cover plate of the automatic cleaning device, and the button assembly includes a soft plastic button cap and a hard plastic bracket. The button cap is assembled on the bracket. The bracket includes a step structure extending in the circumferential direction. In the assembled state, the step structure is a continuously ascending step. The continuously ascending step structure provides a sufficient space for the lower side of the button assembly, so that more components can be accommodated. Meanwhile, the resilience of the bracket is increased, making it easier for the button assembly to return to its original position after being pressed, and further increasing the settable length of the waterproof rib of the top cover, which enhances the waterproof effect of the button assembly.

### BRIEF DESCRIPTION OF THE DRAWINGS

The accompanying drawings, which are incorporated in and constitute a part of this specification, illustrate embodiments consistent with the present application and, together with the description, serve to explain the principles of the present application. Apparently, the accompanying drawings in the following description show merely some embodiments of the present application, and a person of ordinary skill in the art may still derive other drawings from these accompanying drawings without creative efforts. In the accompanying drawings:

FIG. 1 is an oblique view of an automatic cleaning device according to some embodiments of the present application;

FIG. 2 is a schematic diagram of a bottom structure of the automatic cleaning device according to some embodiments of the present application;

FIG. 3 is a schematic diagram of an assembled structure of a button assembly of the automatic cleaning device according to some embodiments of the present application;

FIG. 4 is a schematic diagram of a bracket for a button of the automatic cleaning device from an upper-side perspective according to some embodiments of the present disclosure;

FIG. 5 is a schematic diagram of the bracket for a button of the automatic cleaning device from a lower-side perspective according to some embodiments of the present disclosure;

FIG. 6 is a schematic diagram of a button cap for a button of the automatic cleaning device from an upper-side perspective according to some embodiments of the present disclosure;

FIG. 7 is a schematic diagram of the button cap for a button of the automatic cleaning device from a lower-side perspective according to some embodiments of the present disclosure;

FIG. 8 is a schematic sectional view of the assembled structure of the button assembly of the automatic cleaning device according to some embodiments of the present disclosure;

FIG. 9 is a schematic structural diagram of a cover plate of the automatic cleaning device according to some embodiments of the present disclosure; and

FIG. 10 is an enlarged diagram of a bottom view of the cover plate at D of FIG. 9 according to some embodiments of the present application.

Reference numerals in the drawings are described as below:

moving platform 100; backward portion 110; forward portion 111; sensing system 120; position determination apparatus 121; buffer 122; cliff sensor 123; control system 130; driving system 140; driving wheel assembly 141; steering assembly 142; cleaning module 150; dry cleaning module 151; side brush 152; main brush module 153; dust box 300; filter screen 500; energy system 160; human-machine interaction system 170; cover plate 800; button assembly 900; pressing body portion 911; button mounting hole 802; button cap 910; bracket 920; positioning column 801; positioning hole 925; step structure 930; circuit board 700; first side wall 921; second side wall 922; first assembly portion 923; second assembly portion 924; elastic arm 926; button plate 927; button plate head 9271; button plate tail 9272; first protruding portion 912; second protruding portion 913; third protruding portion 914; first groove 915; second groove 916; recess 917; abutting portion 9171; and shading arm 918.

### DETAILED DESCRIPTION

For clearer descriptions of the purposes, technical solutions and advantages in the present application, the present application is further described in detail hereinafter in combination with the accompanying drawings. Apparently, the described embodiments are merely some embodiments, rather than all embodiments, of the present application. Based on the embodiments of the present application, all other embodiments derived by a person of ordinary skill in the art without creative efforts shall fall within the protection scope of the present application.

The terms used in the embodiments of the present application are only for the purpose of describing specific embodiments, but are not intended to limit the present application. The singular forms “a,” “the” and “said” used in the embodiments and the appended claims of the present application are intended to include the plural forms as well, unless otherwise clearly specified in the context. “A plurality of” generally includes at least two.

It should be understood that the term “and/or” used herein only describes an associated relationship of associated objects, indicating three kinds of relationships. For example, A and/or B can represent that A exists alone, A and B exist concurrently, and B exists alone. In addition, the character “/” herein generally indicates that the associated objects are in an “or” relationship.

It should be understood that although the terms first, second, third, etc. may be used in the embodiments of the present application to describe certain objects, these objects should not be limited by these terms. These terms are merely used to distinguish the objects. For example, a first object may also be referred to as a second object, and similarly, a second object may also be referred to as a first object, without departing from the scope of the embodiments of the present application.

It should also be noted that the terms “comprise,” “include” or any other variants are intended to cover the nonexclusive containing, such that the commodities or apparatuses including a series of elements not only include those elements, but also include other unclearly listed elements, or also include the inherent elements of such commodities or apparatuses. Without more limitations, the element defined by the phrase “comprising a . . . ” does not exclude the existence of other identical elements in the commodity or apparatus that includes such an element.

The embodiments of the present application will be described in detail below with reference to the accompanying drawings.

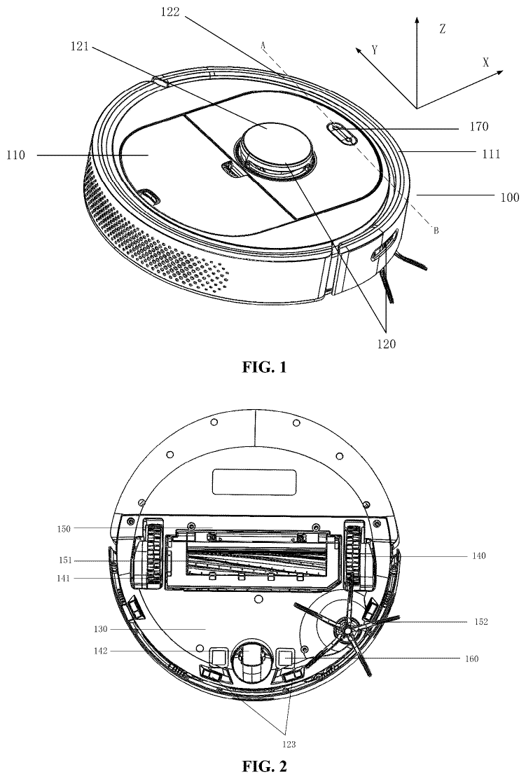

FIGS. 1 and 2 are schematic structural diagrams of an automatic cleaning device according to an exemplary embodiment. As shown in FIGS. 1 and 2, the automatic cleaning device may be a vacuum cleaning robot, a mopping/brushing robot, a window climbing robot, or the like. The automatic cleaning device may include a moving platform 100, a sensing system 120, a control system 130, a driving system 140, a cleaning module 150, an energy system 160, and a human-machine interaction system 170.

The moving platform 100 may be configured to automatically move on an operation surface in a target direction. The operation surface may be a surface to be cleaned by the automatic cleaning device. In some embodiments, the automatic cleaning device may be a mopping robot, in which case the automatic cleaning device works on a floor, and the floor is the operation surface; the automatic cleaning device may also be a window cleaning robot, in which case the automatic cleaning device works on the exterior surface of a glass of a building, and the glass is the operation surface; and the automatic cleaning device may also be a pipeline cleaning robot, in which case the automatic cleaning device works on the interior surface of a pipeline, and the interior surface of the pipeline is the operation surface. Merely for the purpose of illustration, the following descriptions of the present application are given by taking a mopping robot as an example.

In some embodiments, the moving platform 100 may be an autonomous moving platform or a non-autonomous moving platform. The autonomous moving platform means that the moving platform 100 itself can automatically and adaptively make operation decisions according to unexpected environmental inputs. The non-autonomous moving platform itself cannot adaptively make operation decisions according to unexpected environmental inputs; however, it can execute given programs or run according to a certain logic. Correspondingly, in the case that the moving platform 100 is the autonomous moving platform, the target direction may be autonomously determined by the automatic cleaning device; and in the case that the moving platform 100 is the non-autonomous moving platform, the target direction may be set by a system or manually. The moving platform 100 includes a forward portion 111 and a backward portion 110 in the case that the moving platform 100 is the autonomous moving platform.

The sensing system 120 includes a position determination apparatus 121 located above the moving platform 100, a buffer 122 located on the forward portion 111 of the moving platform 100, and sensing devices such as a cliff sensor 123, an ultrasonic sensor (not shown in the figures), an infrared sensor (not shown in the figures), a magnetometer (not shown in the figures), an accelerometer (not shown in the figures), a gyroscope (not shown in the figures) and an odometer (not shown in the figures), or the like, which are located at the bottom of the moving platform for providing various position information and motion state information of the automatic cleaning robot for the control system 130.

For clearer descriptions of the actions of the automatic cleaning device, the following directions are defined as follows. The automatic cleaning device may travel on the floor through various combinations of movements relative to the following three perpendicular axes defined by the moving platform 100: a transverse axis Y, a front-back axis X, and a central vertical axis Z. A forward driving direction along the front-back axis X is marked as “forward,” and a backward driving direction along the front-back axis X is marked as “backward.” The transversal axis Y extends substantially between a right wheel and a left wheel of the automatic cleaning device along an axis center defined by the center point of a driving wheel assembly 141, where the automatic cleaning device may rotate about the axis Y. It is called “pitch up” when the forward portion of the automatic cleaning device tilts upwards and the backward portion thereof tilts downwards, and it is called “pitch down” when the forward portion of the automatic cleaning device tilts downwards and the backward portion thereof tilts upwards. In addition, the automatic cleaning device may rotate around the axis Z. In the forward direction of the automatic cleaning device, it is called “turn right” when the automatic cleaning device tilts to the right of the axis X, and it is called “turn left” when the automatic cleaning device tilts to the left of the axis X.

As shown in FIG. 2, the cliff sensors 123 are provided at the bottom of the moving platform 100 and in the front and rear of the driving wheel assembly 141. The cliff sensors are configured to prevent the automatic cleaning device from falling off when the automatic cleaning device moves back, so as to protect the automatic cleaning device against damage. The aforementioned “front” refers to the side in the same direction as the traveling direction of the automatic cleaning device, and the aforementioned “rear” refers to the side in a direction opposite to the traveling direction of the automatic cleaning device.

A specific type of the position determination apparatus 121 includes, but is not limited to, a camera and a laser distance sensor (LDS).

The various components in the sensing system 120 may work independently or jointly to achieve intended functions more accurately. The surface to be cleaned is identified by the cliff sensor 123 and the ultrasonic sensor to determine the physical properties of the surface to be cleaned, including surface materials, the degree of cleanliness, etc., and more accurate determinations may be performed in combination with the camera, and the laser distance sensor, etc.

For example, it may be determined by the ultrasonic sensor whether the surface to be cleaned is a carpet. If the ultrasonic sensor determines that the surface to be cleaned is made of a carpet material, the control system 130 controls the automatic cleaning device to conduct carpet-mode cleaning.

The buffer 122 is provided on the forward portion 111 of the moving platform 100. The buffer 122 detects one or more events (or objects) in a traveling path of the automatic cleaning device via the sensing system (for example, an infrared sensor) when the driving wheel assembly 141 propels the automatic cleaning device to travel on the floor in the process of cleaning. The automatic cleaning device may control, according to the events (or objects), such as an obstacle and a wall, detected by the buffer 122, the driving wheel assembly 141 to enable the automatic cleaning device to respond to the events (or objects), for example, moving away from the obstacle.

The control system 130 is provided on a main circuit board in the moving platform 100, and includes a computing processor, such as a central processing unit or an application processor, which communicates with a non-transitory memory, such as a hard disk, a flash memory and a random access memory. The application processor is configured to receive environmental information sensed by the plurality of sensors and transmitted from the sensing system 120, to draw a simultaneous map of an environment where the automatic cleaning device is located by using a positioning algorithm (for example, SLAM) according to obstacle information fed back by the laser distance sensor, to autonomously determine the traveling path according to the environmental information and the environmental map, and then to control the driving system 140 to perform operations of moving forward, moving backward and/or turning according to the autonomously determined traveling path. Furthermore, the control system 130 may also determine whether to activate the cleaning module 150 to perform a cleaning operation according to the environmental information and the environmental map.

Specifically, the control system 130 may comprehensively determine a current working state (such as crossing a threshold, getting on a carpet, being at a cliff, being stuck from above or below, having a full dust box or being picked up, etc.) of the sweeping robot in combination with distance information and speed information fed back by the buffer 122, the cliff sensor 123 and the sensing devices, such as the ultrasonic sensor, the infrared sensor, the magnetometer, the accelerometer, the gyroscope and the odometer, and may also give a specific next action strategy for different situations, so that the working of the automatic cleaning device is more in line with the requirements of an owner, thus achieving better user experience. Furthermore, the control system may plan the most efficient and reasonable cleaning path and cleaning mode based on the information of the simultaneous map drawn by SLAM, which greatly improves the cleaning efficiency of the automatic cleaning device.

The driving system 140 may execute a driving command based on a specific distance and angle information, such as components of x, y and θ, to control the automatic cleaning device to travel across the floor. As shown in FIG. 2, the driving system 140 includes a driving wheel assembly 141, and may control a left wheel and a right wheel simultaneously. In order to control the movement of the automatic cleaning device more accurately, the driving system 140 preferably includes a left driving wheel assembly and a right driving wheel assembly that are symmetrically provided along a transverse axis defined by the moving platform 100.

For more stable movement on the floor or higher movement ability of the automatic cleaning device, the automatic cleaning device may include one or more steering components 142. The steering component 142 may be driven wheels or driving wheels, the structure form of which may include, but is not limited to, universal wheels. The steering component 142 may be located in front of the driving wheel assembly 141.

The energy system 160 includes a rechargeable battery, such as a nickel-hydrogen battery or a lithium battery. The rechargeable battery may be connected to a charging control circuit, a battery pack charging temperature detecting circuit, and a battery undervoltage monitoring circuit, which are then connected to a single-chip microcomputer control circuit. A host of the automatic cleaning device is connected to a charging pile by a charging electrode provided on a side of or below the body of the automatic cleaning device for charging. If the exposed charging electrode is covered with dust, due to the accumulative effect of charges in the process of charging, a plastic body around the electrode will be melted and deformed, even resulting in that the electrode itself is deformed and the normal charging cannot be continued.

The human-machine interaction system 170 includes buttons on a panel of the host for a user to select functions, and may further include a display screen and/or an indicator light and/or a speaker, as well as a mobile phone client program. The display screen, the indicator light and the speaker show the current state or function options of the automatic cleaning device to the user. For a route navigation type cleaning device, a mobile phone client may show a map of the environment where the device is located, as well as the location of the device to the user, thus providing the user with richer and more user-friendly function items.

As shown in FIG. 2, the cleaning module 150 may include a dry cleaning module 151.

The dry cleaning module 151 includes a roller brush, a dust box, a fan, and an air outlet. The roller brush in a certain interference with the floor sweeps up debris on the floor and rolls it to the front of a dust suction inlet between the roller brush and the dust box, and then the debris is sucked into the dust box by a gas with a suction force, which is generated by the fan and passes through the dust box. The dust removal capacity of the sweeping robot can be characterized by the dust pickup (DPU) efficiency of the debris, which is affected by the structure and the material of the roller brush, affected by the utilization rate of air in an air passage formed by the dust suction inlet, the dust box, the fan, the air outlet and connecting components among the dust suction inlet, the dust box, the fan and the air outlet, and affected by the type and the power of the fan; and thus, it is a complex problem of system design. The improvement of dust removal capacity is of greater significance to the energy-limited automatic cleaning device compared to an ordinary plug-in vacuum cleaner. This is because the improvement of the dust removal capacity directly and effectively reduces the demand for energy, i.e., an original cleaning device capable of cleaning 80 square meters of the floor with one charge may be improved to clean 180 square meters or more with one charge. In addition, the service life of a battery with a reduced number of charging times may be greatly prolonged, such that the frequency of replacing the battery by the user may be reduced. More intuitively and importantly, the improvement of the dust removal capacity is the most obvious and important user experience, as the user can directly draw a conclusion about whether the thorough sweeping/mopping is achieved. The dry cleaning module may further include a side brush 152 provided with a rotating shaft at a certain angle relative to the floor, for moving the debris into a roller brush area of the cleaning module 150.

As an optional cleaning module, the automatic cleaning device may further include a wet cleaning module configured to clean at least a part of the operation surface in a wet cleaning manner. Among them, the wet cleaning module includes a water tank, a cleaning head, a driving unit, or the like, where water from the water tank flows along a waterway to the cleaning head, and the cleaning head cleans at least a part of the operation surface under the driving of the driving unit.

Pressing structures on cover plates of existing automatic cleaning devices are complex; for example, for most of the button structures of the existing cleaning devices, a soft plastic bracket is provided on a hard plastic bracket, a hard plastic button cap and the soft plastic bracket are bonded together, then the soft plastic bracket and a decorative cover of an upper shell of the automatic cleaning device are bonded together with a double-sided adhesive, and the hard plastic bracket is fixed to the upper shell through a hook at the lower side. For such a button assembly, the structure is complex, there is a large number of parts, the assembling time is long, the production process is complex, and the cost is high. Due to such a multi-layer structure, when the soft plastic bracket is bonded to the decorative cover of the upper shell of the automatic cleaning robot, a deviation in assembly by positioning with a soft plastic is easily caused, and it is difficult to disassemble the button; and during disassembling, it is prone to cause the double-sided adhesive and the soft plastic to be tom up due to the high adhesion between the double-sided adhesive and the soft plastic, and thus the button cannot be used repeatedly.

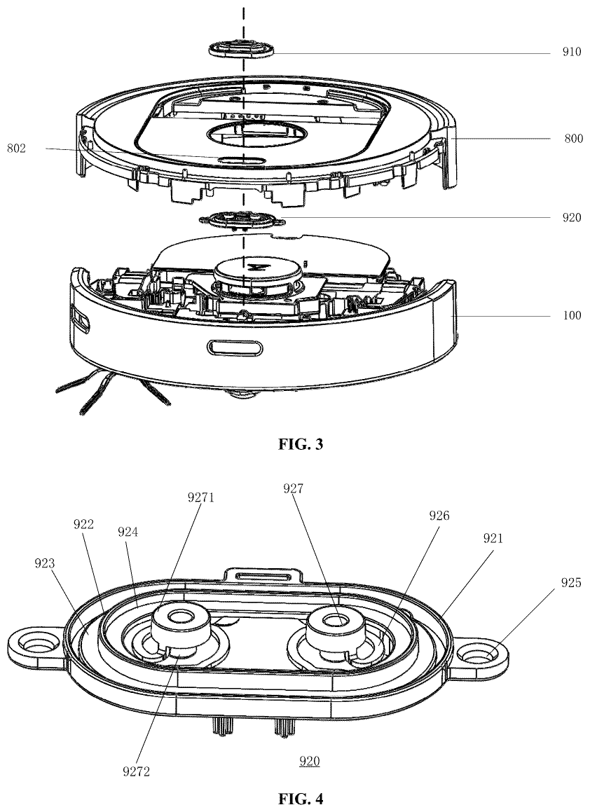

Therefore, embodiments of the present application provide an automatic cleaning device without a flip cover, in which the space between the lower side of a button assembly and the upside of a circuit board is increased, while unnecessary components of the button assembly of the automatic cleaning device are omitted, so that more electronic components can be arranged in the space. Meanwhile, the resilience of the button assembly is increased, making it easier to implement pressings. Specifically, the present application provides an automatic cleaning device. As shown in FIG. 3, according to specific embodiments of the present application, the present application provides an automatic cleaning device, including a moving platform 100 configured to automatically move on an operation surface, where the moving platform 100 includes a cover plate 800, and the cover plate 800 constitutes at least a part of the top surface of the moving platform; and a button assembly 900, configured to be manually operated and pressed to control operations of the automatic cleaning device. The button assembly 900 includes a button cap 910 and a bracket 920, which are assembled on the cover plate 800, where the cover plate 800 includes a button mounting hole 802, the button assembly 900 includes a pressing body portion 911, and the pressing body portion 911 is assembled in the button mounting hole 802, so that a top surface of the pressing body portion is approximately flush with a top surface of the cover plate. A user can apply a force directly by pressing the body during operation, without the need of providing additional decorating parts. In some embodiments, the top surface of the pressing body portion is slightly lower or slightly higher than the top surface of the cover plate, making it easy for the user to locate the position of the button assembly by touch alone. Among them, the button assembly 900 may be applied to any device housing that requires mechanical buttons, including but not limited to a sweeping robot, a mopping robot, a sweeping and mopping robot, a hand-held robot, and a sprinkling robot. The button assembly is usually provided on an upper surface of the housing of a mechanical device, and may also be provided on a side surface of the housing of the mechanical device, which is not limited herein. The housing of the mechanical device is usually made of hard plastic, resin, metal or alloy materials, which is not limited herein.

Specifically, as shown in FIGS. 4-7, the button assembly 900 includes a button cap 910 and a bracket 920. The button cap 910 is usually made of a soft plastic light-tight material to provide the leakproofness, waterproofness and lightproofness during interference assembly. The bracket 920 is usually made of a hard plastic material to provide support during assembly of the button cap, and to fix the button cap in cooperation with the hard cover plate. As shown in FIG. 3, during the assembly process, the soft plastic button cap is first assembled with the cover plate from bottom to top, so that at least the pressing body portion 911 is assembled in the corresponding button mounting bole 802; and then, the hard plastic bracket is assembled under the soft plastic button cap and fixed by a positioning column 801 on the cover plate 800 and a positioning hole 925 in the bracket 920, so as to form the button assembly. The two circular positioning holes 925 in the button bracket and the positioning column 801 of a snap-on structure on the cover plate simultaneously serve the function of positioning, so that the button cap 910 is assembled between the bracket 920 and the cover plate.

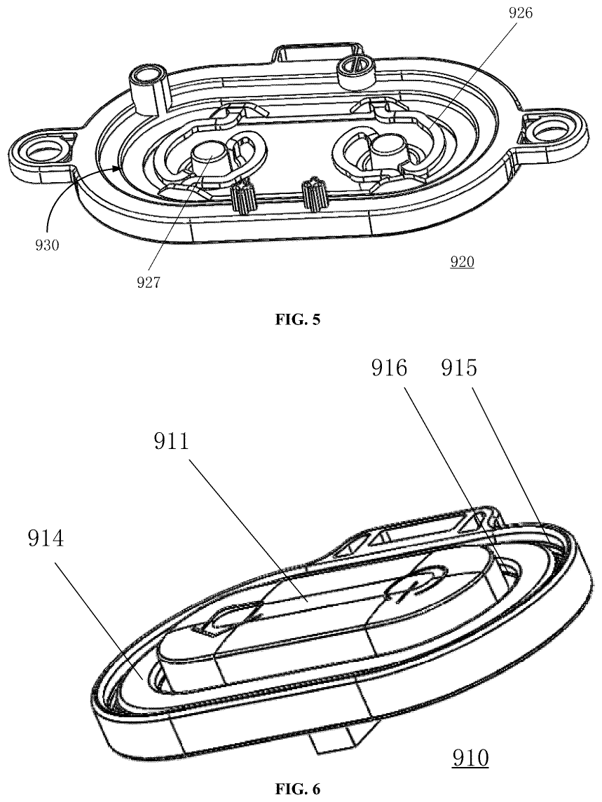

In some embodiments, as shown in FIG. 5, the bracket 920 includes a step structure 930 extending in a circumferential direction. In an assembled state, the step structure is a step continuously ascending from outside to inside or from inside to outside. Compared with a bracket that is relatively flat and regular on the whole, an elevated portion in the step structure can provide a layout space and a design freedom for other components, so that the space at the upper portion of the bracket is effectively utilized. Specifically, the direction of the step can be designed according to space requirements of other components. Optionally, in the assembled state, the step structure is a step continuously ascending from outside to inside, and the step continuously ascending from outside to inside not only increases an extra space, but also the increased extra space is in the middle, which is conductive to providing a sufficient space correspondingly below the pressing body portion, which is required for implementing a pressing action. The pressing stroke is reasonably set and the elasticity is restored, so as to enhance the user experience. Each step of the step structure 930 extends circumferentially parallel to an overall peripheral contour shape of the bracket 920 in a surrounding manner to form a closed structure, such as a surrounding closed ellipse, circle, square, rectangle, etc., which is not limited herein. The step structure 930 is a substantially tapered step structure formed by steps continuously ascending from outside to inside, and extends upwards from outer-ring steps to inner-ring steps. The specific number of steps is not limited; for example, there are 2-5 steps. As another example, there are 2-3 steps. As shown in FIGS. 4-5, each step is not limited in width and height, and the steps may be of equal width and equal height, or unequal widths and unequal heights. According to the step structure 930 that the bracket 920 extends in the circumferential direction, there is a larger overhanging space under the bracket. As a butted circuit board 700 is located under the bracket, as shown in FIG. 8, the overhanging space can improve the convenience of designing components for the circuit board relative to a confined space, so that the space originally occupied by the lower portion of the bracket can be used to provide more electronic components. In addition, according to the step structure 930 that the bracket 920 extends in the circumferential direction, there is a larger overhanging space under the bracket, which improves the resilience of the hard bracket. After a pressing force applied to the button assembly is transmitted to the hard bracket, the bracket is more prone to elastic deformation and is easier to restore after being subject to the elastic deformation, which brings a better touch feeling for the button assembly and improves the convenience of pressing contact of the device.

In some embodiments, as shown in FIG. 4, the bracket 920 includes a first side wall 921 extending circumferentially and continuously along an outer edge of the bracket 920 and a second side wall 922 extending circumferentially and continuously along an interior of the bracket 920, where a first assembly portion 923 is formed between the first side wall 921 and the second side wall 922, and a second assembly portion 924 is formed inside the second side wall 922. The first side wall 921 and the second side wall 922 extend circumferentially parallel to an overall peripheral contour shape of the bracket 920 in a surrounding manner to form a closed structure, such as a surrounding closed ellipse, circle, square, rectangle, etc., which is not limited herein. The first side wall 921 and the second side wall 922, which extend in a closed manner, form the first assembly portion 923 and the second assembly portion 924 for accommodating a first protruding portion 912 and a second protruding portion 913 of the button cap, thus playing a role in fixing and supporting the button cap as a whole.

Specifically, in some embodiments, at least a part of the step structure is located on the first assembly portion 923, and another part of the step structure is located on the second assembly portion 924. For example, the first assembly portion 923 includes at least one step structure, and the second assembly portion 924 includes the highest step surface of the step structure. The first side wall 921 and the second side wall 922 substantially form a high-low structure as the step structure 930 ascends. For example, the second side wall 922 is higher than the first side wall 921, allowing for more stable supporting for the button cap and more complete sealing.

In some embodiments, each of two ends of the bracket 920 includes a positioning hole 925, a lower surface of the cover plate is provided with a positioning column 801 corresponding to the positioning hole 925, and the positioning column 801 passes through the positioning hole 925 to realize fixation of the bracket 920. Optionally, a side wall of the positioning column 801 includes at least one protrusion, so that the positioning column 801 and the positioning hole 925 are assembled in an interference fit manner, thus securely fixing the bracket 920 to the lower surface of the cover plate while providing an upward pressing force to fix the button cap 910.

In some embodiments, the bracket 920 further includes a button plate 927 connected by at least one elastic arm 926, the button plate is configured to move downwards under an external force to implement a pressing function, and the elastic arm 926 is configured to restore the button plate 927. As shown in FIG. 4, the button plate 927 is usually located inside the bracket, and includes a pair of button plates that are symmetrically provided. The button plate 927 includes a button plate head 9271 in contact with an abutting portion 9171 of the button cap and a button plate tail 9272 in press contact with components of the circuit board 700. Generally, the width of the button plate head 9271 is greater than the width of the button plate tail 9272. The width of the button plate head 9271 is greater, which is convenient for receiving the pressing force; and the button plate tail 9272 is smaller, which is convenient for accurate contact with and pressing on an element to avoid mis-pressing. The button plate 927 is connected to an inner edge of the bracket 920 through the elongated elastic arms 926, and one or more elongated elastic arms 926 are provided around the button plate 927 to provide the button plate 927 with sufficient pressing and restoration resilience.

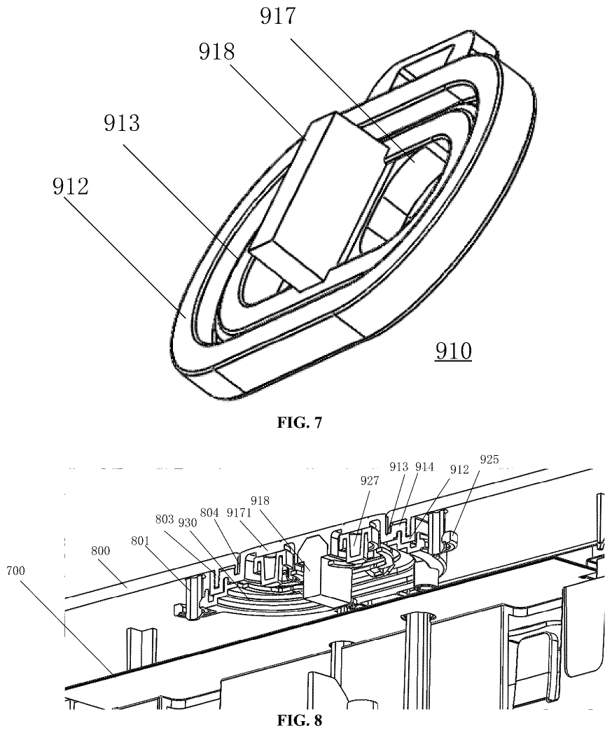

In some embodiments, as shown in FIGS. 6 and 7, the button cap 910 includes a pressing body portion 911 substantially located in the center of the button cap 910, and a first protruding portion 912 and a second protruding portion 913 that extend downwards around the pressing body portion 911. The first protruding portion 912 and the second protruding portion 913 extend circumferentially parallel to a contour shape of the pressing body portion 911 in a surrounding manner to form a closed structure. Among them, the first protruding portion 912 and the second protruding portion 913 are adapted to the first assembly portion 923 and the second assembly portion 924, respectively, when the button cap 910 is assembled on the bracket 920. In order to match with the step structure inside the first assembly portion 923 and the second assembly portion 924, the length of the first protruding portion 912 extending downwards is greater than the length of the second protruding portion 913 extending downwards. The first protruding portion 912 and the second protruding portion 913 may be assembled on the first assembly portion 923 and the second assembly portion 924 in an interference fit manner, respectively, so as to improve the stability and leakproofness of the button cap assembly.

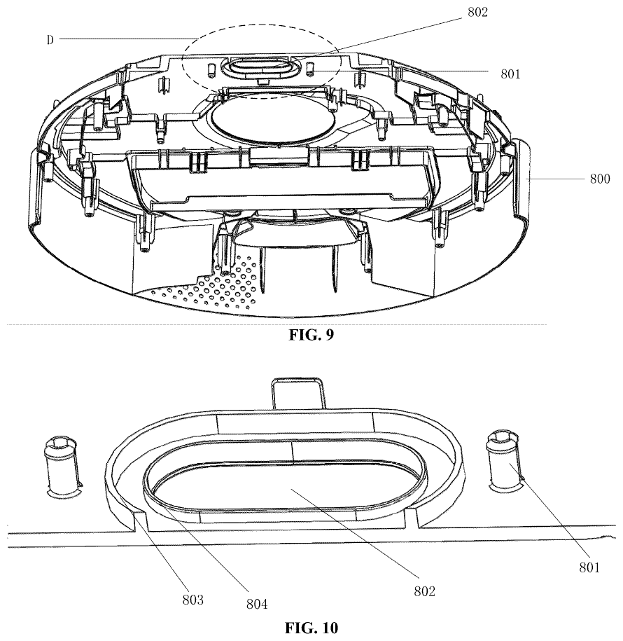

In some embodiments, as shown in FIG. 6, an upper surface of the button cap 910 includes a third protruding portion 914 connecting the first protruding portion 912 to the second protruding portion 913, and the third protruding portion 914 extends upwards around the pressing body portion 911. The third protruding portion 914 extends circumferentially parallel to the contour shape of the pressing body portion 911 in a surrounding manner to form a closed structure. The button cap 910 further includes a first groove 915 and a second groove 916 extending along two sides of the third protruding portion 914 in a surrounding manner, where the depth of the first groove 915 is greater than the depth of the second groove 916. As shown in FIGS. 9-10, FIG. 10 is an enlarged diagram of a bottom view of the cover plate at D of FIG. 9. The cover plate 800 includes a button mounting hole 802, and the pressing body portion 911 is assembled in the button mounting hole 802. At this time, an edge portion 804 extending downwards is provided around an edge of the button mounting hole 802, and the edge portion is inserted into the second groove 916 around the pressing body portion 911 as the pressing body portion 911 is inserted into the button mounting hole 802 from bottom to top. The edge portion 804 constitutes one of waterproof ribs of the cover plate 800, and a side wall of the edge portion 804 may include at least one protrusion, so that the pressing body portion 911 and the button mounting hole 802 are assembled in an interference fit manner, thus realizing tight connection and achieving the effects of waterproofness and light leakage prevention. Furthermore, in some embodiments, the cover plate 800 includes a waterproof rib 803 extending downwards around the button mounting hole 802, the waterproof rib 803 is assembled in the first groove 915, and a side wall of the waterproof rib 803 may include at least one protrusion, so that the waterproof rib 803 is assembled in the first groove 915 in an interference fit manner. As the pressing body portion 911 is inserted into the button mounting hole 802, the edge portion of the button mounting hole 802 is inserted into the second groove 916 around the pressing body portion 911, and the waterproof rib 803 is also inserted into the first groove 915. Besides, the length of downward extension of the waterproof rib 803 is greater than the length of the edge portion of the button mounting hole 802, which further enables the pressing body portion 911 to be more tightly connected to the button mounting hole 802, thus achieving more favorable effects of waterproofness and light leakage prevention.

In some embodiments, as shown in FIGS. 7-8, in which FIG. 8 is a sectional view taken along line AB in FIG. 1, the second protruding portion 913 includes two recesses 917 provided at intervals, and in the assembled state, the recesses 917 are configured to accommodate the button plate 927. A top end of the recess 917 is provided with an abutting portion 9171. The button plate head 9271 closely abuts against the abutting portion 9171 after the button cap and the bracket are assembled, facilitating reception of the pressing force.

In some embodiments, as shown in FIGS. 7-8, a shading arm 918 extending downwards is provided between the two recesses 917 provided at intervals. The shading arm 918 is made of a light-tight material, and may also be formed by applying a light-tight material, which can avoid forming an optical interference between optical elements associated with a pressing operation and the button plates 927, after the button plates 927 located on two sides press the components on the circuit board 700, so as to avoid effect of the user's acquisition of optical prompt information. The shading arm 918 and the button cap may be integrally formed, or may be processed and synthesized later by means of bonding, clamping, etc., which is not limited herein.

The present application provides an automatic cleaning device, in which the button assembly is assembled on the cover plate of the automatic cleaning device, and the button assembly includes a soft plastic button cap and a hard plastic bracket. The button cap is assembled on the bracket. The bracket includes a step structure extending in the circumferential direction. In the assembled state, the step structure is a step continuously ascending from outside to inside. The continuously ascending step structure provides a sufficient space for the lower side of the button assembly, so that more components can be accommodated. Meanwhile, the resilience of the bracket is increased, making it easier for the button assembly to return to its original position after being pressed. Furthermore, the settable length of the waterproof rib of the top cover is increased, which enhances the waterproof effect of the button assembly.

Finally, it should be noted that the various embodiments in the Description are described in a progressive manner, each embodiment focuses on the differences from the other embodiments, and the same or similar parts between the various embodiments may be referred to each other.

The above embodiments are only used to illustrate, instead of limiting, the technical solutions of the present disclosure. Although the present disclosure is described in detail with reference to the foregoing embodiments, it may be understood by those of ordinary skill in the art that they can still make modifications to the technical solutions disclosed in the above various embodiments or equivalent replacements on part of the technical features, and these modifications or replacements do not depart the nature of the corresponding technical solution from the spirit and scope of the technical solutions of the various embodiments of the present disclosure.

1. An automatic cleaning device, comprising:
a moving platform, configured to automatically move on an operation surface and comprising a cover plate, wherein the cover plate constitutes at least a part of a top surface of the moving platform; and
a button assembly, assembled on the cover plate, wherein the button assembly comprises a button cap and a bracket, the button cap is assembled on the bracket, and the bracket comprises a step structure extending in a circumferential direction.

2. The automatic cleaning device according to claim 1, wherein in an assembled state, the step structure is a step continuously ascending from outside to inside.

3. The automatic cleaning device according to claim 1, wherein the bracket comprises at least one side wall, and an assembly portion is formed on an inner side of the at least one side wall.

4. The automatic cleaning device according to claim 1, wherein the bracket comprises a first side wall extending circumferentially and continuously along an outer edge of the bracket and a second side wall extending circumferentially and continuously along an interior of the bracket, a first assembly portion is formed between the first side wall and the second side wall, and a second assembly portion is formed inside the second side wall.

5. The automatic cleaning device according to claim 4, wherein at least a part of the step structure is located on the first assembly portion, and another part of the step structure is located on the second assembly portion.

6. The automatic cleaning device according to claim 1, wherein each of two ends of the bracket comprises a positioning hole, a lower surface of the cover plate is provided with a positioning column corresponding to the positioning hole, and the positioning column passes through the positioning hole to realize fixation of the bracket.

7. The automatic cleaning device according to claim 4, wherein the bracket further comprises a button plate connected by at least one elastic arm, the button plate is configured to move downwards under an external force to implement a pressing function, and the elastic arm is configured to restore the button plate.

8. The automatic cleaning device according to claim 3, wherein the button cap comprises a pressing body portion and at least one protruding portion extending downwards around the pressing body portion, wherein when the button cap is assembled on the bracket, the at least one protruding portion is adapted to the assembly portion formed on the inner side of the at least one side wall.

9. The automatic cleaning device according to claim 7, wherein the button cap comprises a first protruding portion and a second protruding portion extending downwards around the pressing body portion, and the first protruding portion and the second protruding portion are adapted to the first assembly portion and the second assembly portion respectively when the button cap is assembled on the bracket.

10. The automatic cleaning device according to claim 9, wherein the button cap comprises a third protruding portion connecting the first protruding portion to the second protruding portion, and the third protruding portion extends upwards around the pressing body portion.

11. The automatic cleaning device according to claim 10, wherein the button cap further comprises a first groove and a second groove extending along two sides of the third protruding portion in a surrounding manner, and a depth of the first groove is greater than a depth of the second groove.

12. The automatic cleaning device according to claim 11, wherein the cover plate comprises a button mounting hole, and the pressing body portion is assembled in the button mounting hole, so that a top surface of the pressing body portion is approximately flush with or slightly lower than a top surface of the cover plate.

13. The automatic cleaning device according to claim 12, wherein the cover plate further comprises at least one waterproof rib extending downwards around the button mounting hole, and the at least one waterproof rib is assembled in at least one of the first groove and/or the second groove.

14. The automatic cleaning device according to claim 13, wherein a side wall of the at least one waterproof rib comprises a protrusion, and the at least one waterproof rib is assembled in at least one of the first groove or the second groove in an interference fit manner through the protrusion.

15. The automatic cleaning device according to claim 14, wherein the cover plate comprises a first waterproof rib and a second waterproof rib extending downwards around the button mounting hole, the first waterproof rib is assembled in the first groove, and the second waterproof rib is assembled in the second groove.

16. The automatic cleaning device according to claim 9, wherein the second protruding portion comprises two recesses provided at intervals, and in the assembled state, the recesses are configured to accommodate the button plate.

17. The automatic cleaning device according to claim 16, wherein a shading arm extending downwards is provided between the two recesses provided at intervals.

18. The automatic cleaning device according to claim 16, wherein an abutting portion is provided on a top end of a recess.

19. The automatic cleaning device according to claim 18, wherein the button plate comprises a button plate head in contact with the abutting portion and a button plate tail in press contact with components of a circuit board; and
a width of the button plate head is greater than a width of the button plate tail.

20. An automatic cleaning system, comprising an automatic cleaning device, wherein the automatic cleaning device comprises:
a moving platform, configured to automatically move on an operation surface and comprising a cover plate, wherein the cover plate constitutes at least a part of a top surface of the moving platform; and
a button assembly, assembled on the cover plate, wherein the button assembly comprises a button cap and a bracket, the button cap is assembled on the bracket, and the bracket comprises a step structure extending in a circumferential direction.
